(19) United States
(12) Patent Application Publication
(10) Pub. No.: US 2018/0249386 A1
(43) Pub. Date: Aug. 30, 2018

(54) CAMPED CELL DETERMINING METHOD, USER EQUIPMENT, AND NETWORK DEVICE

(71) Applicant: Huawei Technologies Co., Ltd., Shenzhen (CN)

(72) Inventors: Ping Song, Shanghai (CN); Hongzhuo Zhang, Shanghai (CN)

(21) Appl. No.: 15/966,526

(22) Filed: Apr. 30, 2018

Related U.S. Application Data
(63) Continuation of application No. PCT/CN2015/093419, filed on Oct. 30, 2015.

(51) Int. Cl. H04W 36/00; H04W 36/06; H04W 36/04; H04W 36/30

(52) U.S. Cl. CPC H04W 36/0083; H04W 36/0055; H04W 36/30; H04W 36/04; H04W 36/06

(57) ABSTRACT

Embodiments of the present disclosure provide a camped cell determining method, user equipment (UE), and a network device. The method includes: determining, by UE, whether the UE needs to reselect a cell; if no, obtaining, by the UE, parameter information of a camped cell and parameter information of at least one non-camped cell; determining, by the UE according to the parameter information of the camped cell and parameter information of any non-camped cell, whether a preset condition is met; if yes, using, by the UE, the corresponding non-camped cell as a candidate cell; and selecting, by the UE from at least one candidate cell, a cell corresponding to maximum parameter information as a new camped cell, or selecting, from at least one candidate cell, any candidate cell as a new camped cell.

### CROSS-REFERENCE TO RELATED APPLICATIONS

This application is a continuation of International Application No. PCT/CN2015/093419, filed on Oct. 30, 2015, the disclosure of which is hereby incorporated by reference in its entirety.

### TECHNICAL FIELD

Embodiments of the present disclosure relate to communications technologies, and in particular, to a camped cell determining method, user equipment, and a network device.

### BACKGROUND

User equipment (UE) enters an idle mode after being powered on. To obtain a normal service, after selecting a public land mobile network (PLMN), the UE selects a suitable cell that belongs to the PLMN, to camp on. The process is referred to as a cell selection process. The cell selection process needs to meet a criterion S.

Signal strength of a serving cell and that of a neighboring cell vary with movement of the UE, and therefore the UE needs to reselect a most suitable cell to camp on. The process is referred to as cell reselection. During cell reselection, a candidate cell also needs to meet the criterion S. A cell reselection criterion includes a quality level threshold criterion H and a cell queuing criterion R. For a hierarchical cell structure (HCS), the criterion H determines whether to queue cells in a priority-based order according to a hierarchical cell reselection rule. If a system message indicates that the HCS is not used, the criterion R is used instead of the criterion H.

Regardless of the criterion H or the criterion R, a relatively large quantity of reselection parameters such as a frequency priority, a frequency offset, and a reselection threshold are used during cell reselection, and network coverage is diversified. Therefore, the UE may be unable to meet all cell reselection conditions, and therefore can camp only on a current cell. There may be the following case: Signal strength or signal quality of the currently camped cell of the UE is worse than signal strength or signal quality of another cell, and therefore the currently camped cell has a higher network disconnection rate, call loss rate, and the like than the another cell, leading to lower communication reliability.

### SUMMARY

Embodiments of the present disclosure provide a camped cell determining method, user equipment, and a network device, to improve communication reliability.

According to a first aspect, an embodiment of the present disclosure provides a camped cell determining method, including: determining, by user equipment (UE), whether the UE needs to reselect a cell; if the UE does not need to reselect the cell, obtaining, by the UE, parameter information of a camped cell and parameter information of at least one non-camped cell; determining, by the UE according to the parameter information of the camped cell and parameter information of any non-camped cell, whether a preset condition is met, where the preset condition is used to ensure that the parameter information of the non-camped cell is greater than the parameter information of the camped cell; if the preset condition is met, using, by the UE, the corresponding non-camped cell as a candidate cell; and selecting, by the UE from at least one candidate cell, a cell corresponding to maximum parameter information as a new camped cell, or selecting, from at least one candidate cell, any candidate cell as a new camped cell.

With reference to the first aspect, in a first possible implementation of the first aspect, the parameter information includes reference signal received power (RSRP) or reference signal received quality (RSRQ).

With reference to the first aspect or the first possible implementation of the first aspect, in a second possible implementation of the first aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

According to a second aspect, an embodiment of the present disclosure provides a camped cell determining method, including: determining, by user equipment (UE), whether the UE needs to reselect a cell; if the UE does not need to reselect the cell, obtaining, by the UE, parameter information of a camped cell and parameter information of at least one non-camped cell; determining, by the UE according to the parameter information of the camped cell and parameter information of any non-camped cell, whether a preset condition is met, where the preset condition is used to ensure that the parameter information of the non-camped cell is greater than the parameter information of the camped cell; if the preset condition is met, sending, by the UE, an indication message to a network device, where the indication message is used to indicate that the camped cell is a poor camped cell, or the indication message is used to indicate a quantity of times that the camped cell is a poor camped cell, so that the network device performs radio frequency (RF) optimization on the camped cell or optimizes a reselection parameter of the camped cell; and camping, by the UE, on an optimized camped cell.

With reference to the second aspect, in a first possible implementation of the second aspect, the parameter information includes reference signal received power (RSRP) or reference signal received quality (RSRQ).

With reference to the second aspect or the first possible implementation of the second aspect, in a second possible implementation of the second aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the second aspect, or the first possible implementation or the second possible implementation of the second aspect, in a third possible implementation of the second aspect, the network device is a base station or an operations support system (OSS) device.

According to a third aspect, an embodiment of the present disclosure provides a camped cell determining method, including: receiving, by a network device, an indication message sent by user equipment (UE), where the indication message is used to indicate that a camped cell is a poor camped cell, or the indication message is used to indicate a quantity of times that a camped cell is a poor camped cell; and performing, by the network device, radio frequency (RF) optimization on the camped cell or optimizing a reselection parameter of the camped cell, so that the UE camps on an optimized camped cell.

With reference to the third aspect, in a first possible implementation of the third aspect, the network device is a base station or an operations support system (OSS) device.

According to a fourth aspect, an embodiment of the present disclosure provides a camped cell determining method, including: receiving, by a network device, a first indication message sent by user equipment (UE), where the first indication message is used to indicate that the UE does not meet a cell reselection condition; obtaining, by the network device, measurement data of the UE, where the measurement data includes parameter information of a camped cell and parameter information of at least one non-camped cell of the UE; determining, by the network device according to the parameter information of the camped cell and parameter information of any non-camped cell, whether a preset condition is met; and if the preset condition is met, performing, by the network device, radio frequency (RF) optimization on the camped cell or optimizing a reselection parameter of the camped cell, so that the UE camps on an optimized camped cell; or if the preset condition is met, sending, by the network device, a second instruction message to the UE, where the second instruction message is used to instruct the UE to use the corresponding non-camped cell as a candidate cell, so that the UE selects, from at least one candidate cell, a cell corresponding to maximum parameter information as a new camped cell, or selects, from at least one candidate cell, any candidate cell as a new camped cell, where the preset condition is used to ensure that the parameter information of the non-camped cell is greater than the parameter information of the camped cell.

With reference to the fourth aspect, in a first possible implementation of the fourth aspect, the parameter information includes reference signal received power (RSRP) or reference signal received quality (RSRQ).

With reference to the fourth aspect or the first possible implementation of the fourth aspect, in a second possible implementation of the fourth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the fourth aspect, or the first possible implementation or the second possible implementation of the fourth aspect, in a third possible implementation of the fourth aspect, the network device is a base station or an operations support system (OSS) device.

According to a fifth aspect, an embodiment of the present disclosure provides a camped cell determining method, including: sending, by user equipment (UE), a first indication message to a network device, where the first indication message is used to indicate that the UE does not meet a cell reselection condition; and receiving, by the UE, a second instruction message sent by the network device, where the second instruction message is used to instruct the UE to use, as a candidate cell, a non-camped cell that meets a preset condition, so that the UE selects, from at least one candidate cell, a cell corresponding to maximum parameter information as a new camped cell, or selects, from at least one candidate cell, any candidate cell as a new camped cell, where the preset condition is used to ensure that parameter information of the non-camped cell is greater than parameter information of a camped cell.

With reference to the fifth aspect, in a first possible implementation of the fifth aspect, the parameter information includes reference signal received power (RSRP) or reference signal received quality (RSRQ).

With reference to the fifth aspect or the first possible implementation of the fifth aspect, in a second possible implementation of the fifth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the fifth aspect, or the first possible implementation or the second possible implementation of the fifth aspect, in a third possible implementation of the fifth aspect, the network device is a base station or an operations support system (OSS) device.

According to a sixth aspect, an embodiment of the present disclosure provides user equipment, including a determining module, an obtaining module, and a selection module, where the determining module is configured to determine whether the user equipment needs to reselect a cell; if the UE does not need to reselect the cell, the obtaining module obtains parameter information of a camped cell and parameter information of at least one non-camped cell; the determining module is further configured to determine, according to the parameter information of the camped cell and parameter information of any non-camped cell, whether a preset condition is met; if the preset condition is met, the user equipment uses the corresponding non-camped cell as a candidate cell; the selection module is configured to: select, from at least one candidate cell, a cell corresponding to maximum parameter information as a new camped cell, or select, from at least one candidate cell, any candidate cell as a new camped cell; and the preset condition is used to ensure that the parameter information of the non-camped cell is greater than the parameter information of the camped cell.

With reference to the sixth aspect, in a first possible implementation of the sixth aspect, the parameter information includes reference signal received power (RSRP) or reference signal received quality (RSRQ).

With reference to the sixth aspect or the first possible implementation of the sixth aspect, in a second possible implementation of the sixth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

According to a seventh aspect, an embodiment of the present disclosure provides user equipment, including a determining module, an obtaining module, and a sending module, where the determining module is configured to determine whether the user equipment needs to reselect a cell; if the UE does not need to reselect the cell, the obtaining module obtains parameter information of a camped cell and parameter information of at least one non-camped cell; the determining module is further configured to determine, according to the parameter information of the camped cell and parameter information of any non-camped cell, whether a preset condition is met; if the preset condition is met, the sending module sends an indication message to a network device, where the indication message is used to indicate that the camped cell is a poor camped cell, or the indication message is used to indicate a quantity of times that the camped cell is a poor camped cell, so that the network device performs radio frequency (RF) optimization on the camped cell or optimizes a reselection parameter of the camped cell; the user equipment camps on an optimized camped cell; and the preset condition is used to ensure that the parameter information of the non-camped cell is greater than the parameter information of the camped cell.

With reference to the seventh aspect, in a first possible implementation of the seventh aspect, the parameter information includes reference signal received power (RSRP) or reference signal received quality (RSRQ).

With reference to the seventh aspect or the first possible implementation of the seventh aspect, in a second possible implementation of the seventh aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the seventh aspect, or the first possible implementation or the second possible implementation of the seventh aspect, in a third possible implementation of the seventh aspect, the network device is a base station or an operations support system (OSS) device.

According to an eighth aspect, an embodiment of the present disclosure provides a network device, including a receiving module and an optimization module, where the receiving module is configured to receive an indication message sent by user equipment (UE), where the indication message is used to indicate that a camped cell is a poor camped cell, or the indication message is used to indicate a quantity of times that a camped cell is a poor camped cell; and the optimization module is configured to: perform radio frequency (RF) optimization on the camped cell or optimize a reselection parameter of the camped cell, so that the UE camps on an optimized camped cell.

With reference to the eighth aspect, in a first possible implementation of the eighth aspect, the network device is a base station or an operations support system (OSS) device.

According to a ninth aspect, an embodiment of the present disclosure provides a network device, including a receiving module, an obtaining module, a determining module, an optimization module, and a sending module, where the receiving module is configured to receive a first indication message sent by user equipment (UE), where the first indication message is used to indicate that the UE does not meet a cell reselection condition; the obtaining module is configured to obtain measurement data of the UE, where the measurement data includes parameter information of a camped cell and parameter information of at least one non-camped cell of the UE; the determining module is configured to determine, according to the parameter information of the camped cell and parameter information of any non-camped cell, whether a preset condition is met; if the preset condition is met, the optimization module performs radio frequency (RF) optimization on the camped cell or optimizes a reselection parameter of the camped cell, so that the UE camps on an optimized camped cell; or if the preset condition is met, the sending module sends a second instruction message to the UE, where the second instruction message is used to instruct the UE to use the corresponding non-camped cell as a candidate cell, so that the UE selects, from at least one candidate cell, a cell corresponding to maximum parameter information as a new camped cell, or selects, from at least one candidate cell, any candidate cell as a new camped cell; and the preset condition is used to ensure that the parameter information of the non-camped cell is greater than the parameter information of the camped cell.

With reference to the ninth aspect, in a first possible implementation of the ninth aspect, the parameter information includes reference signal received power (RSRP) or reference signal received quality (RSRQ).

With reference to the ninth aspect or the first possible implementation of the ninth aspect, in a second possible implementation of the ninth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the ninth aspect, or the first possible implementation or the second possible implementation of the ninth aspect, in a third possible implementation of the ninth aspect, the network device is a base station or an operations support system (OSS) device.

According to a tenth aspect, an embodiment of the present disclosure provides user equipment, including a sending module and a receiving module, where the sending module is configured to send a first indication message to a network device, where the first indication message is used to indicate that the user equipment (UE) does not meet a cell reselection condition; the receiving module is configured to receive a second instruction message sent by the network device, where the second instruction message is used to instruct the UE to use, as a candidate cell, a non-camped cell that meets a preset condition, so that the UE selects, from at least one candidate cell, a cell corresponding to maximum parameter information as a new camped cell, or selects, from at least one candidate cell, any candidate cell as a new camped cell; and the preset condition is used to ensure that parameter information of the non-camped cell is greater than parameter information of a camped cell.

With reference to the tenth aspect, in a first possible implementation of the tenth aspect, the parameter information includes reference signal received power (RSRP) or reference signal received quality (RSRQ).

With reference to the tenth aspect or the first possible implementation of the tenth aspect, in a second possible implementation of the tenth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the tenth aspect, or the first possible implementation or the second possible implementation of the tenth aspect, in a third possible implementation of the tenth aspect, the network device is a base station or an operations support system (OSS) device.

According to an eleventh aspect, an embodiment of the present disclosure provides user equipment, including a processor, where the processor is configured to determine whether the user equipment needs to reselect a cell; if the UE does not need to reselect the cell, the processor obtains parameter information of a camped cell and parameter information of at least one non-camped cell; the processor is further configured to determine, according to the parameter information of the camped cell and parameter information of any non-camped cell, whether a preset condition is met; if the preset condition is met, the user equipment uses the corresponding non-camped cell as a candidate cell; the processor is further configured to: select, from at least one candidate cell, a cell corresponding to maximum parameter information as a new camped cell, or select, from at least one candidate cell, any candidate cell as a new camped cell; and the preset condition is used to ensure that the parameter information of the non-camped cell is greater than the parameter information of the camped cell.

With reference to the eleventh aspect, in a first possible implementation of the eleventh aspect, the parameter information includes reference signal received power (RSRP) or reference signal received quality (RSRQ).

With reference to the eleventh aspect or the first possible implementation of the eleventh aspect, in a second possible implementation of the eleventh aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

According to a twelfth aspect, an embodiment of the present disclosure provides user equipment, including a processor and a transmitter, where the processor is configured to determine whether the user equipment needs to reselect a cell; if the UE does not need to reselect the cell, the processor obtains parameter information of a camped cell and parameter information of at least one non-camped cell; the processor is further configured to determine, according to the parameter information of the camped cell and parameter information of any non-camped cell, whether a preset condition is met; if the preset condition is met, the transmitter sends an indication message to a network device, where the indication message is used to indicate that the camped cell is a poor camped cell, or the indication message is used to indicate a quantity of times the camped cell is a poor camped cell, so that the network device performs radio frequency (RF) optimization on the camped cell or optimizes a reselection parameter of the camped cell; the user equipment camps on an optimized camped cell; and the preset condition is used to ensure that the parameter information of the non-camped cell is greater than the parameter information of the camped cell.

With reference to the twelfth aspect, in a first possible implementation of the twelfth aspect, the parameter information includes reference signal received power (RSRP) or reference signal received quality (RSRQ).

With reference to the twelfth aspect or the first possible implementation of the twelfth aspect, in a second possible implementation of the twelfth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the twelfth aspect, or the first possible implementation or the second possible implementation of the twelfth aspect, in a third possible implementation of the twelfth aspect, the network device is a base station or an operations support system (OSS) device.

According to a thirteenth aspect, an embodiment of the present disclosure provides a network device, including a receiver and a processor, where the receiver is configured to receive an indication message sent by user equipment (UE), where the indication message is used to indicate that a camped cell is a poor camped cell, or the indication message is used to indicate a quantity of times that a camped cell is a poor camped cell; and the processor is configured to: perform radio frequency (RF) optimization on the camped cell or optimize a reselection parameter of the camped cell, so that the UE camps on an optimized camped cell.

With reference to the thirteenth aspect, in a first possible implementation of the thirteenth aspect, the network device is a base station or an operations support system (OSS) device.

According to a fourteenth aspect, an embodiment of the present disclosure provides a network device, including a receiver, a processor, and a transmitter, where the receiver is configured to receive a first indication message sent by user equipment (UE), where the first indication message is used to indicate that the UE does not meet a cell reselection condition; the processor is configured to obtain measurement data of the UE, where the measurement data includes parameter information of a camped cell and parameter information of at least one non-camped cell of the UE; the processor is further configured to determine, according to the parameter information of the camped cell and parameter information of any non-camped cell, whether a preset condition is met; if the preset condition is met, the processor performs radio frequency (RF) optimization on the camped cell or optimizes a reselection parameter of the camped cell, so that the UE camps on an optimized camped cell; or if the preset condition is met, the transmitter sends a second instruction message to the UE, where the second instruction message is used to instruct the UE to use the corresponding non-camped cell as a candidate cell, so that the UE selects, from at least one candidate cell, a cell corresponding to maximum parameter information as a new camped cell, or selects, from at least one candidate cell, any candidate cell as a new camped cell; and the preset condition is used to ensure that the parameter information of the non-camped cell is greater than the parameter information of the camped cell.

With reference to the fourteenth aspect, in a first possible implementation of the fourteenth aspect, the parameter information includes reference signal received power (RSRP) or reference signal received quality (RSRQ).

With reference to the fourteenth aspect or the first possible implementation of the fourteenth aspect, in a second possible implementation of the fourteenth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the fourteenth aspect, or the first possible implementation or the second possible implementation of the fourteenth aspect, in a third possible implementation of the fourteenth aspect, the network device is a base station or an operations support system (OSS) device.

According to a fifteenth aspect, an embodiment of the present disclosure provides user equipment, including a transmitter and a receiver, where the transmitter is configured to send a first indication message to a network device, where the first indication message is used to indicate that the user equipment (UE) does not meet a cell reselection condition; the receiver is configured to receive a second instruction message sent by the network device, where the second instruction message is used to instruct the UE to use, as a candidate cell, a non-camped cell that meets a preset condition, so that the UE selects, from at least one candidate cell, a cell corresponding to maximum parameter information as a new camped cell, or selects, from at least one candidate cell, any candidate cell as a new camped cell; and the preset condition is used to ensure that parameter information of the non-camped cell is greater than parameter information of a camped cell.

With reference to the fifteenth aspect, in a first possible implementation of the fifteenth aspect, the parameter information includes reference signal received power (RSRP) or reference signal received quality (RSRQ).

With reference to the fifteenth aspect or the first possible implementation of the fifteenth aspect, in a second possible implementation of the fifteenth aspect, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

With reference to the fifteenth aspect, or the first possible implementation or the second possible implementation of the fifteenth aspect, in a third possible implementation of the fifteenth aspect, the network device is a base station or an operations support system (OSS) device.

The embodiments of the present disclosure provide the camped cell determining method, the user equipment, and the network device. The method may include the following steps: The UE determines whether the UE needs to reselect a cell; if the UE does not need to reselect the cell, the UE obtains the parameter information of the camped cell and the parameter information of the at least one non-camped cell; the UE determines, according to the parameter information of the camped cell and the parameter information of the any non-camped cell, whether the preset condition is met; if the preset condition is met, the UE uses the corresponding non-camped cell as the candidate cell; and the UE selects, from the at least one candidate cell, the cell corresponding to the maximum parameter information as the new camped cell, or selects, from the at least one candidate cell, the any candidate cell as the new camped cell. The preset condition is used to ensure that the parameter information of the non-camped cell is greater than the parameter information of the camped cell. Therefore, the UE can select a better cell from the camped cell and the non-camped cell to camp on, and the camped cell used after the updating has a lower network disconnection rate and call loss rate, so that communication reliability is ensured.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a flowchart of a camped cell determining method according to an embodiment of the present disclosure;

FIG. 2 is an interaction flowchart of a camped cell determining method according to an embodiment of the present disclosure;

FIG. 3 is a schematic diagram of a relationship between UE, a base station, and an OSS device;

FIG. 4 is an interaction flowchart of a camped cell determining method according to another embodiment of the present disclosure;

FIG. 5 is an interaction flowchart of a camped cell determining method according to still another embodiment of the present disclosure;

FIG. 6A and FIG. 6B are a schematic diagram of an MDT enhancement mechanism according to the present disclosure;

FIG. 7 is a schematic structural diagram of user equipment according to an embodiment of the present disclosure;

FIG. 8 is a schematic structural diagram of user equipment according to another embodiment of the present disclosure;

FIG. 9 is a schematic structural diagram of a network device according to an embodiment of the present disclosure;

FIG. 10 is a schematic structural diagram of a network device according to another embodiment of the present disclosure;

FIG. 11 is a schematic structural diagram of user equipment according to still another embodiment of the present disclosure;

FIG. 12 is a schematic structural diagram of user equipment according to an embodiment of the present disclosure;

FIG. 13 is a schematic structural diagram of user equipment according to another embodiment of the present disclosure;

FIG. 14 is a schematic structural diagram of a network device according to an embodiment of the present disclosure;

FIG. 15 is a schematic structural diagram of a network device according to another embodiment of the present disclosure; and

FIG. 16 is a schematic structural diagram of user equipment according to still another embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by persons of ordinary skill in the art based on the embodiments of the present disclosure without creative efforts shall fall within the protection scope of the present disclosure.

The present disclosure is applicable to determining a camped cell in one type of communications systems, and is also applicable to determining a camped cell in different types of communications systems. The communications system herein may be the global system for mobile communications (GSM) system or code division multiple access (CDMA) system or the like of 2G system, time division-synchronous code division multiple access (TD-SCDMA) system or wideband code division multiple access (WCDMA) system or the like of 3G system, time division long term evolution (TD-LTE) system or LTE-FDD system of 4G, a related system of a standard later than 4G or the like.

User equipment (UE) enters an idle mode after being powered on. To obtain a normal service, after selecting a public land mobile network PLMN, the UE needs to enter a cell selection process. The cell selection process needs to meet a criterion S.

The criterion S has the following conditions:

For a frequency division duplex (FDD) cell, Srxlev>0 and Squal>0; and

for a time division duplex (TDD) cell, Squal>0, where

Squal=Qqualmeas−(Qqualmin+Qqualminoffset); and

Srxlev=Qrxlevmeas−(Qrxlevmin+Qrxlevminoffset)−Pcompensation. For specific parameters, refer to Table 1.

TABLE 1

| Parameter | Description |
|---|---|
| Squal | Cell selection quality value (dB), used only |
| | for an FDD cell |
| Srxlev | Cell selection received signal level value (dBm) |
| Qqualmeas | Measured cell quality value, used only for |
| | an FDD cell For the FDD cell, received signal |
| | quality is indicated by an average common |
| | pilot channel (CPICH) Ec/No (dB) |
| Qrxlevmeas | Measured cell received signal level value |
| | CPICH received signal code power (RSCP) of a |
| | received signal is used for an FDD cell (dBm) |
| | Primary common control physical |
| | channel (P-CCPCH) RSCP of a received |
| | signal is used for a TDD cell (dBm) |
| Qqualmin | Minimum quality standard, where if signal |
| | quality of a cell is lower than the value, |
| | it may be considered that UE is out |
| | of a service scope of the current cell |
| Qrxlevmin | Minimum access level, where if signal |
| | quality of a cell is lower than the |
| | value, it may be considered that UE is |
| | out of a service scope of the current cell |
| Pcompensation | max(UE_TXPWR_MAX_RACH-P_MAX, 0) |
| | (dB) |
| | UE_TXPWR_MAX_RACH is maximum |
| | allowed uplink transmit power of UE |
| | P_MAX is maximum carrier output power |
| | of the UE (dBm) |
| | According to a network coverage plan, |
| | UE_TXPWR_MAX_RACH is set on a |
| | networkside. When the maximum transmit |
| | power of the UE is less than the parameter |
| | value, Pcompensation determines a |
| | scaling extent of actual cell coverage, |
| | that is, Pcompensation is a value of |
| | compensation caused by limitation of the |
| | maximum transmit power of the UE |

Signal strength of a serving cell and that of a neighboring cell vary with movement of the UE, and therefore the UE needs to reselect a most suitable cell to camp on. The process is referred to as cell reselection. During cell reselection, a candidate cell also needs to meet the criterion S. A cell reselection criterion includes a quality level threshold criterion H and a cell queuing criterion R. For a hierarchical cell structure HCS, the criterion H determines whether to queue cells in a priority-based order according to a hierarchical cell reselection rule. If a system message indicates that the HCS is not used, the criterion R is used instead of the criterion H.

Regardless of the criterion H or the criterion R, a relatively large quantity of reselection parameters such as a frequency priority, a frequency offset, and a reselection threshold are used during cell reselection, and network coverage is diversified. Therefore, the UE may be unable to meet all cell reselection conditions, and therefore can camp only on a current cell. There may be the following case: Signal strength or signal quality of the currently camped cell of the UE is worse than signal strength or signal quality of another cell, and therefore the currently camped cell has a higher network disconnection rate, call loss rate, and the like than the another cell, leading to lower communication reliability.

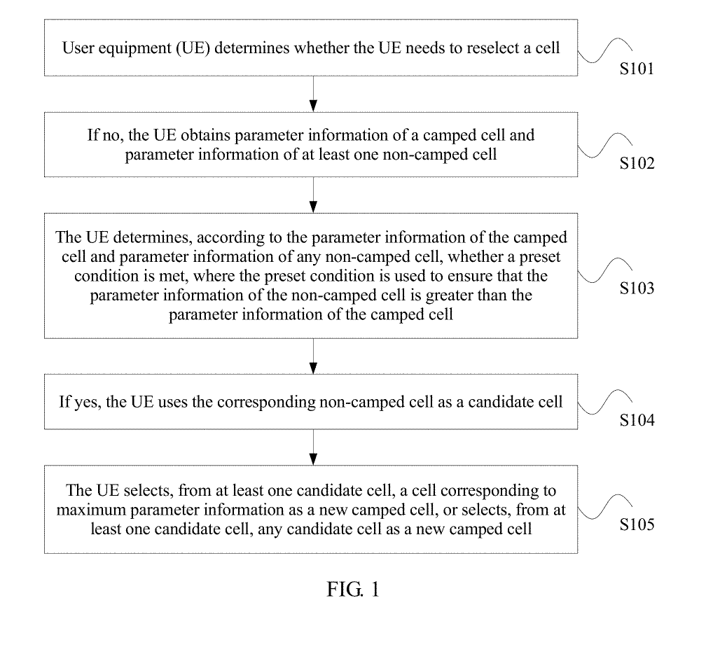

To resolve the prior-art problem, FIG. 1 is a flowchart of a camped cell determining method according to an embodiment of the present disclosure. The method is executed by user equipment (UE). As shown in FIG. 1, the method may include the following procedure.

S101. The user equipment (UE) determines whether the UE needs to reselect a cell.

S102. If the UE does not need to reselect the cell, the UE obtains parameter information of a camped cell and parameter information of at least one non-camped cell.

For example, S101 and S102 are described as follows: The UE determines, by using a criterion H or a criterion R, whether the UE needs to reselect a cell. A cell reselection method is the same as that in the prior art, and details are not described herein. After the UE determines that the UE does not meet a cell reselection condition, the UE obtains the parameter information of the camped cell and the parameter information of the at least one non-camped cell. The parameter information may be reference signal received power (RSRP) or reference signal received quality (RSRQ).

S103. The UE determines, according to the parameter information of the camped cell and parameter information of any non-camped cell, whether a preset condition is met, where the preset condition is used to ensure that the parameter information of the non-camped cell is greater than the parameter information of the camped cell.

For example, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold. The preset condition may be embedded in a cell selection/reselection process in the 3rd generation partnership project (3GPP) 304, that is, may be carried in any message in the process. Alternatively, the preset condition may be sent by a base station to the UE by using a broadcast message, a paging message, a release message, a handover message, or the like. A method for obtaining the preset condition is not limited in this embodiment of the present disclosure. It should be noted that the non-camped cell means that the UE is in a coverage area of the non-camped cell, but the UE does not camp on the cell.

S104. If the preset condition is met, the UE uses the corresponding non-camped cell as a candidate cell.

S105. The UE selects, from at least one candidate cell, a cell corresponding to maximum parameter information as a new camped cell, or selects, from at least one candidate cell, any candidate cell as a new camped cell.

With reference to S104 and S105, for example, the parameter information is RSRQ, the camped cell of the UE is A, and non-camped cells are B, C, and D. The UE determines that RSRQ of the camped cell A is less than the first threshold, and the UE determines that both RSRQ of the non-camped cell B and that of the non-camped cell C are greater than the second threshold. Therefore, the UE uses the non-camped cell B and the non-camped cell C as candidate cells. Finally, the UE randomly selects B or C as a new camped cell; or the UE compares the RSRQ of B with that of C, and selects a cell corresponding to better RSRQ as a new camped cell.

The camped cell determining method provided in this embodiment of the present disclosure may include the following steps: The user equipment (UE) determines whether the UE needs to reselect a cell; if the UE does not need to reselect the cell, the UE obtains the parameter information of the camped cell and the parameter information of the at least one non-camped cell; the UE determines, according to the parameter information of the camped cell and the parameter information of the any non-camped cell, whether the preset condition is met; if the preset condition is met, the UE uses the corresponding non-camped cell as the candidate cell; and the UE selects, from the at least one candidate cell, the cell corresponding to the maximum parameter information as the new camped cell, or selects, from the at least one candidate cell, the any candidate cell as the new camped cell. The preset condition is used to ensure that the parameter information of the non-camped cell is greater than the parameter information of the camped cell. Therefore, when the UE does not meet cell reselection condition, the UE can still select a better cell from the camped cell and the non-camped cell to camp on. The camped cell used after the updating has a lower network disconnection rate and call loss rate than the camped cell used before the updating, so that communication reliability is ensured.

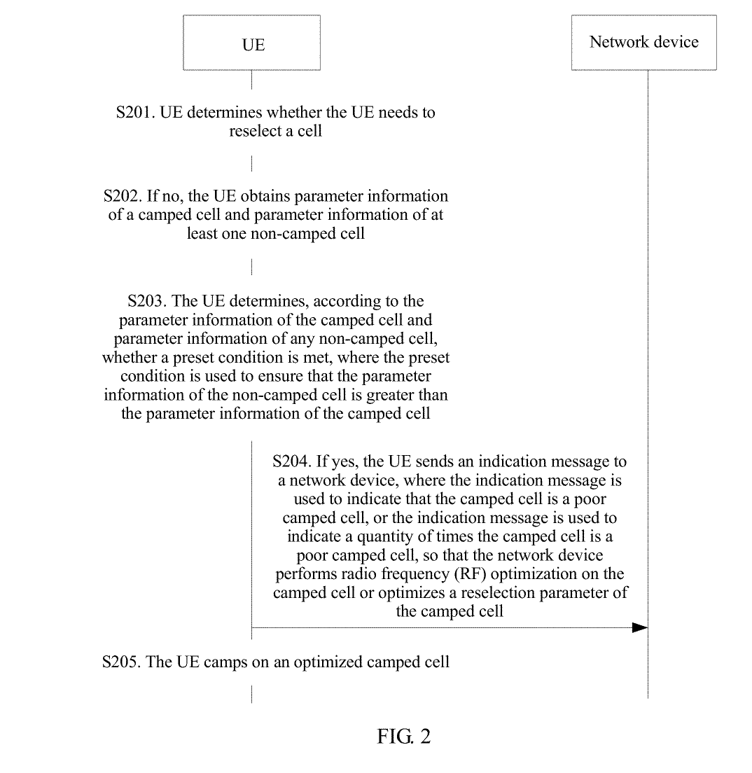

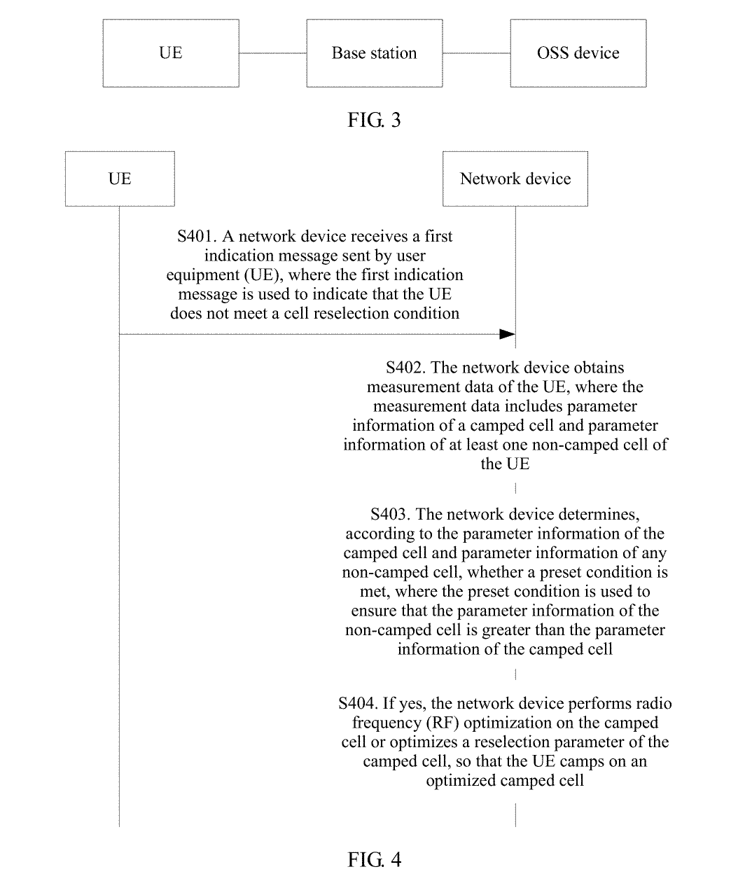

FIG. 2 is an interaction flowchart of a camped cell determining method according to an embodiment of the present disclosure. Network elements in the method include UE and a network device. It should be noted that, the network device herein may be a base station or an operations support system (OSS) device. A difference between the method and the method corresponding to FIG. 1 is as follows: After the UE determines that parameter information of a camped cell and parameter information of any non-camped cell meet a preset condition, the UE sends an indication message to the network device, so that the network device optimizes the camped cell according to the indication message. FIG. 3 is a schematic diagram of a relationship between UE, a base station, and an OSS device. As shown in FIG. 3, when the network device is an OSS device, the UE interacts with the OSS device by using the base station. The following specifically describes the camped cell determining method. As shown in FIG. 2, the method may include the following steps.

S201. The user equipment (UE) determines whether the UE needs to reselect a cell.

S202. If the UE does not need to reselect the cell, the UE obtains parameter information of a camped cell and parameter information of at least one non-camped cell.

S203. The UE determines, according to the parameter information of the camped cell and parameter information of any non-camped cell, whether a preset condition is met, where the preset condition is used to ensure that the parameter information of the non-camped cell is greater than the parameter information of the camped cell.

For example, a process of steps S201 to S203 is the same as that of steps S101 to S103, and details are not described herein again.

S204. If the preset condition is met, the UE sends an indication message to the network device, where the indication message is used to indicate that the camped cell is a poor camped cell, or the indication message is used to indicate a quantity of times that the camped cell is a poor camped cell, so that the network device performs radio frequency (RF) optimization on the camped cell or optimizes a reselection parameter of the camped cell.

S205. The UE camps on an optimized camped cell.

With reference to S204 and S205, the camped cell is a poor camped cell provided that the UE does not meet a reselection condition but meets the preset condition. In one case, the indication message is used to indicate that the camped cell is a poor camped cell. In another case, because the UE may frequently move, the camped cell of the UE may be a poor camped cell in a time period, and may not be a poor camped cell in another time period. The UE may collect, in a preset period, statistics on the quantity of times the camped cell is a poor camped cell, and send the quantity of times to the network device, so that the network device performs radio frequency (RF) optimization on the camped cell or optimizes the reselection parameter of the camped cell. It should be noted that the indication message may be a radio resource control (RRC) setup request message, a minimization of drive tests (MDT) message, a location area code (LAC) update message, or the like.

In an optional manner, the RF optimization is to ensure good reception quality while network coverage is optimized. In addition, a network has a correct neighbor relationship, so as to ensure that radio signals are normally distributed during next-step service optimization, to lay a good foundation for optimization. For example, the RF optimization may include a manner, for example, adjusting antenna delivery power, an azimuth, or a downtilt of the camped cell. For example, coverage quality of the camped cell may be changed by increasing the antenna delivery power, adjusting the azimuth, increasing the downtilt, or the like. An RF optimization method provided in the prior art may be specifically used, and the optimization method is not limited in the present disclosure.

In another optional manner, the network device may optimize the reselection parameter of the camped cell, such as a frequency priority or a cell reselection threshold. The frequency priority may be optimized by increasing or decreasing the frequency priority, and the cell reselection threshold may be optimized by decreasing or increasing the cell reselection threshold. Therefore, the UE can select a cell with better strength/quality as a camped cell. For example, in terms of the reselection parameter, the cell reselection threshold may need to be greater than −105 dBm, but signal quality of a target cell is −106 dBm and quality of the camped cell is −125 dBm. Therefore, currently, the UE cannot reach the target cell. In this case, the reselection threshold may be changed to −106 dBm. In this way, the UE can reach the target cell instead of camping on the camped cell. Generally, a manner of optimizing the reselection parameter and a manner of selecting a better camped cell by the UE may be referred to as radio resource management (RRM) optimization.

In the camped cell determining method provided in this embodiment of the present disclosure, the UE sends the indication message to the network device, so that the network device can perform RF optimization on the camped cell or optimize the reselection parameter of the camped cell, and then it is ensured that the UE can camp on a cell with better RSRP or RSRQ, and communication reliability is improved.

FIG. 4 is an interaction flowchart of a camped cell determining method according to another embodiment of the present disclosure. Network elements in the method include UE and a network device. The network device is a base station or an OSS device. A difference between the method and the method corresponding to FIG. 1 is as follows: In the method, the network device determines, according to parameter information of a camped cell and parameter information of any non-camped cell, whether a preset condition is met, and finally, the network device optimizes the camped cell. As shown in FIG. 4, the method may include the following procedure.

S401. The network device receives a first indication message sent by the user equipment (UE), where the first indication message is used to indicate that the UE does not meet a cell reselection condition.

The UE determines, according to a criterion H and a criterion R, whether the UE meets the cell reselection condition.

S402. The network device obtains measurement data of the UE, where the measurement data includes parameter information of a camped cell and parameter information of at least one non-camped cell of the UE.

The measurement data may be MDT data or measurement report (MR) data. The parameter information includes reference signal received power (RSRP) or reference signal received quality (RSRQ).

S403. The network device determines, according to the parameter information of the camped cell and parameter information of any non-camped cell, whether a preset condition is met, where the preset condition is used to ensure that the parameter information of the non-camped cell is greater than the parameter information of the camped cell.

For example, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

S404. If the preset condition is met, the network device performs radio frequency (RF) optimization on the camped cell or optimizes a reselection parameter of the camped cell, so that the UE camps on an optimized camped cell.

A method in which the network device performs radio frequency (RF) optimization on the camped cell or optimizes the reselection parameter of the camped cell is the same as the optimization method in S204, and details are not described herein again.

In the camped cell determining method provided in this embodiment of the present disclosure, the UE sends the first indication message to the network device, so that the network device can perform RF optimization on the camped cell or optimize the reselection parameter of the camped cell, and then it is ensured that the UE can camp on a cell with better RSRP or RSRQ, and communication reliability is improved.

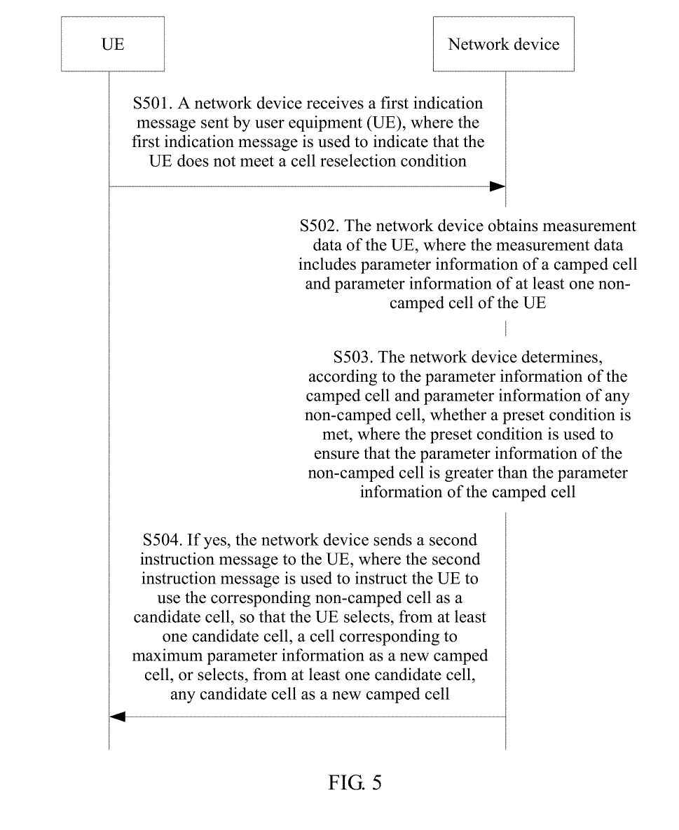

FIG. 5 is an interaction flowchart of a camped cell determining method according to still another embodiment of the present disclosure. Network elements in the method include UE and a network device. The network device is a base station or an OSS device. A difference between the method and the method corresponding to FIG. 1 is as follows: In the method, the network device determines, according to parameter information of a camped cell and parameter information of any non-camped cell, whether a preset condition is met. As shown in FIG. 5, the method may include the following procedure:

S501. The network device receives a first indication message sent by the user equipment (UE), where the first indication message is used to indicate that the UE does not meet a cell reselection condition.

S502. The network device obtains measurement data of the UE, where the measurement data includes parameter information of a camped cell and parameter information of at least one non-camped cell of the UE.

S503. The network device determines, according to the parameter information of the camped cell and parameter information of any non-camped cell, whether a preset condition is met, where the preset condition is used to ensure that the parameter information of the non-camped cell is greater than the parameter information of the camped cell.

S504. If the preset condition is met, the network device sends a second instruction message to the UE, where the second instruction message is used to instruct the UE to use the corresponding non-camped cell as a candidate cell, so that the UE selects, from at least one candidate cell, a cell corresponding to maximum parameter information as a new camped cell, or selects, from at least one candidate cell, any candidate cell as a new camped cell.

For example, S501 to S503 are the same as steps S401 to S403, and details are not described herein again. The corresponding non-camped cell in step S504 is a non-camped cell that meets the preset condition. Finally, the UE selects, from the candidate cell, the cell corresponding to the maximum parameter information as the new camped cell, or selects, from the candidate cell, the any candidate cell as the new camped cell.

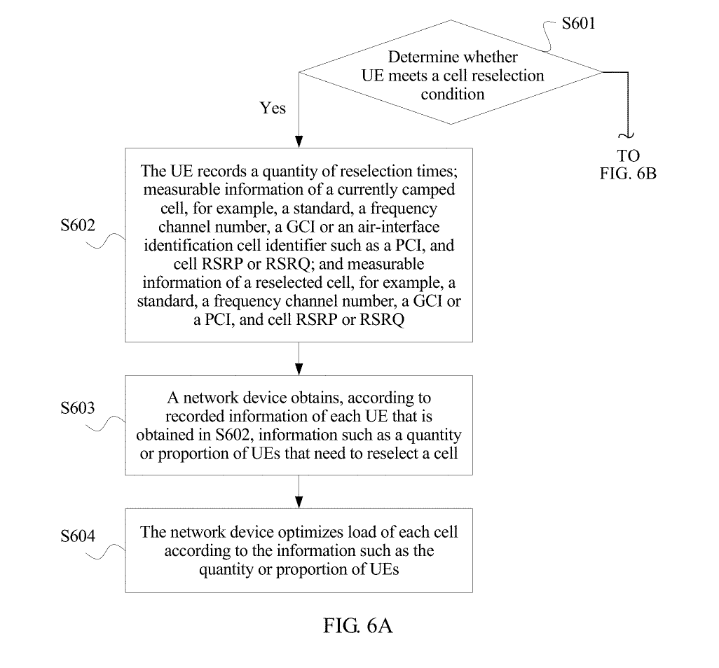

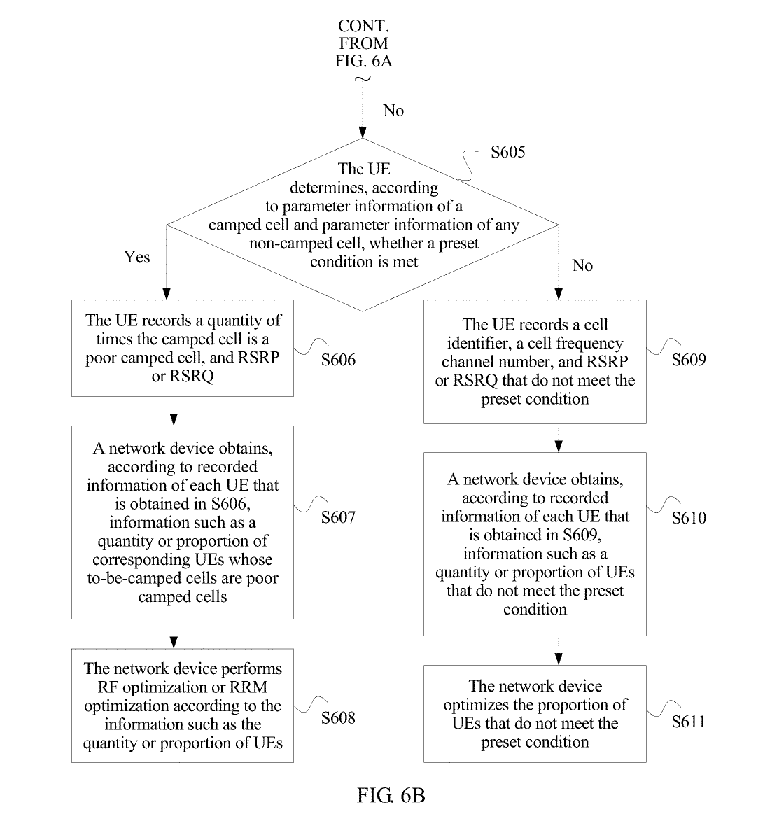

The UE may further notify the network device of information, for example, information that the camped cell of the UE is a poor camped cell, a quantity of times that the camped cell of the UE is a poor camped cell, or a quantity of cell reselection times, so that the network device optimizes load of each cell, the camped cell, or the like according to the information. For example, FIG. 6A and FIG. 6B are a schematic diagram of an MDT enhancement mechanism according to the present disclosure. As shown in FIG. 6A and FIG. 6B. The mechanism may include the following steps.

S601. Determine whether UE meets a cell reselection condition; and if the UE meets the cell reselection condition, perform step S602; or if the UE does not meet the cell reselection condition, perform step S605.

S602. The UE records a quantity of reselection times; measurable information of a currently camped cell, for example, a standard, a frequency channel number, a global cell identity (GCI) or an air-interface identification cell identifier such as an LTE cell identifier: a physical cell identifier (PCI), and cell RSRP or RSRQ; and measurable information of a reselected cell, for example, a standard, a frequency channel number, a GCI or a PCI, and cell RSRP or RSRQ.

S603. A network device obtains, according to recorded information of each UE that is obtained in S602, information such as a quantity or proportion of UEs that need to reselect a cell.

S604. The network device optimizes load of each cell according to the information such as the quantity or proportion of UEs.

S605. The UE determines, according to parameter information of a camped cell and parameter information of any non-camped cell, whether a preset condition is met; and if the preset condition is met, performs S606; or if the preset condition is not met, performs S609.

S606. The UE records a quantity of times the camped cell is a poor camped cell, and RSRP or RSRQ.

S607. A network device obtains, according to recorded information of each UE that is obtained in S606, information such as a quantity or proportion of UEs corresponding to a poor camped cell.

S608. The network device performs RF optimization or RRM optimization according to the information such as the quantity or proportion of UEs.

S609. The UE records a cell identifier, a cell frequency channel number, and RSRP or RSRQ that do not meet the preset condition.

S610. A network device obtains, according to recorded information of each UE that is obtained in S609, information such as a quantity or proportion of UEs that do not meet the preset condition.

S611. The network device optimizes the proportion of UEs that do not meet the preset condition.

The MDT mechanism includes: The network device optimizes the load of each cell, the camped cell, or the like according to the information, for example, the information that the camped cell is a poor camped cell, the quantity of times the camped cell is a poor camped cell, or the quantity of cell reselection times, so as to improve communication reliability.

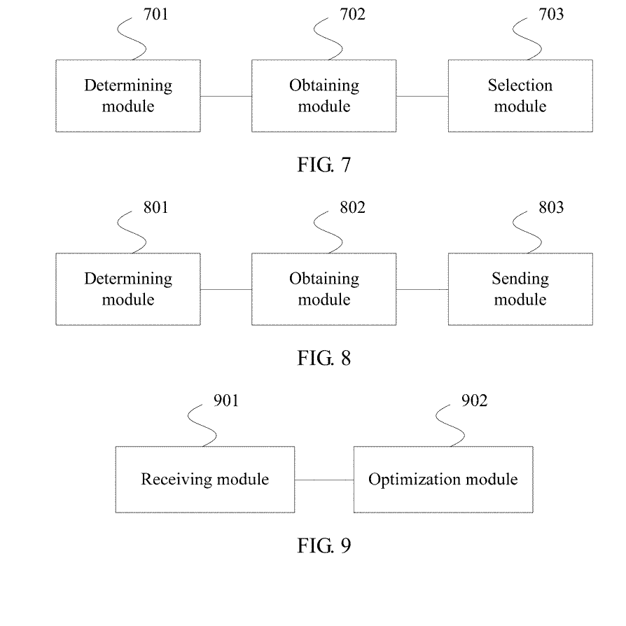

FIG. 7 is a schematic structural diagram of user equipment according to an embodiment of the present disclosure. The user equipment includes a determining module 701, an obtaining module 702, and a selection module 703. The determining module 701 is configured to determine whether the user equipment needs to reselect a cell. If the UE does not need to reselect the cell, the obtaining module 702 obtains parameter information of a camped cell and parameter information of at least one non-camped cell. The determining module 701 is further configured to determine, according to the parameter information of the camped cell and parameter information of any non-camped cell, whether a preset condition is met. If the preset condition is met, the user equipment uses the corresponding non-camped cell as a candidate cell. The selection module 703 is configured to: select, from at least one candidate cell, a cell corresponding to maximum parameter information as a new camped cell, or select, from at least one candidate cell, any candidate cell as a new camped cell. The preset condition is used to ensure that the parameter information of the non-camped cell is greater than the parameter information of the camped cell.

The parameter information includes reference signal received power (RSRP) or reference signal received quality (RSRQ).

Further, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The user equipment provided in this embodiment may be configured to perform the method steps in the embodiment shown in FIG. 1. Implementation principles and technical effects are similar, and details are not described herein again.

FIG. 8 is a schematic structural diagram of user equipment according to another embodiment of the present disclosure. The user equipment includes a determining module 801, an obtaining module 802, and a sending module 803. The determining module 801 is configured to determine whether the user equipment needs to reselect a cell. If the UE does not need to reselect the cell, the obtaining module 802 obtains parameter information of a camped cell and parameter information of at least one non-camped cell. The determining module 801 is further configured to determine, according to the parameter information of the camped cell and parameter information of any non-camped cell, whether a preset condition is met. If the preset condition is met, the sending module 803 sends an indication message to a network device, where the indication message is used to indicate that the camped cell is a poor camped cell, or the indication message is used to indicate a quantity of times the camped cell is a poor camped cell, so that the network device performs radio frequency (RF) optimization on the camped cell or optimizes a reselection parameter of the camped cell. The user equipment camps on an optimized camped cell. The preset condition is used to ensure that the parameter information of the non-camped cell is greater than the parameter information of the camped cell.

The parameter information includes reference signal received power (RSRP) or reference signal received quality (RSRQ).

Further, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The network device is a base station or an operations support system (OSS) device.

The user equipment provided in this embodiment may be configured to perform the method steps corresponding to the UE in the embodiment shown in FIG. 2. Implementation principles and technical effects are similar, and details are not described herein again.

FIG. 9 is a schematic structural diagram of a network device according to an embodiment of the present disclosure. The network device includes a receiving module 901 and an optimization module 902. The receiving module 901 is configured to receive an indication message sent by user equipment (UE), where the indication message is used to indicate that a camped cell is a poor camped cell, or the indication message is used to indicate a quantity of times that a camped cell is a poor camped cell. The optimization module 902 is configured to: perform radio frequency (RF) optimization on the camped cell or optimize a reselection parameter of the camped cell, so that the UE camps on an optimized camped cell.

The network device is a base station or an operations support system (OSS) device.

The network device provided in this embodiment may be configured to perform the method steps corresponding to the network device in the embodiment shown in FIG. 2. Implementation principles and technical effects are similar, and details are not described herein again.

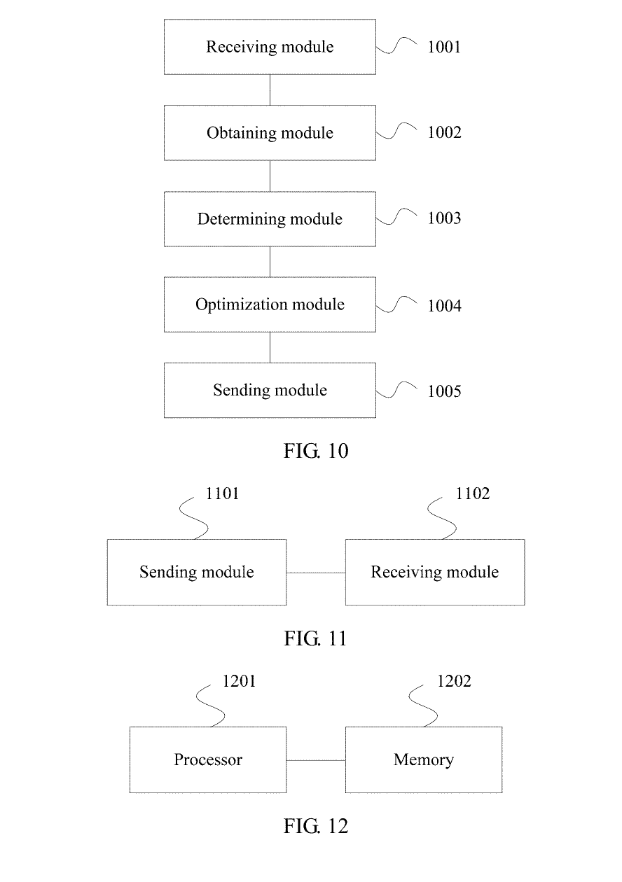

FIG. 10 is a schematic structural diagram of a network device according to another embodiment of the present disclosure. The network device includes a receiving module 1001, an obtaining module 1002, a determining module 1003, an optimization module 1004, and a sending module 1005. The receiving module 1001 is configured to receive a first indication message sent by user equipment (UE), where the first indication message is used to indicate that the UE does not meet a cell reselection condition. The obtaining module 1002 is configured to obtain measurement data of the UE, where the measurement data includes parameter information of a camped cell and parameter information of at least one non-camped cell of the UE. The determining module 1003 is configured to determine, according to the parameter information of the camped cell and parameter information of any non-camped cell, whether a preset condition is met. If the preset condition is met, the optimization module 1004 performs radio frequency (RF) optimization on the camped cell or optimizes a reselection parameter of the camped cell, so that the UE camps on an optimized camped cell; or if the preset condition is met, the sending module 1005 sends a second instruction message to the UE, where the second instruction message is used to instruct the UE to use the corresponding non-camped cell as a candidate cell, so that the UE selects, from at least one candidate cell, a cell corresponding to maximum parameter information as a new camped cell, or selects, from at least one candidate cell, any candidate cell as a new camped cell. The preset condition is used to ensure that the parameter information of the non-camped cell is greater than the parameter information of the camped cell.

Further, the parameter information includes reference signal received power (RSRP) or reference signal received quality (RSRQ).

Still further, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The network device is a base station or an operations support system (OSS) device.

The network device provided in this embodiment may be configured to perform the method steps corresponding to the network device in the embodiment shown in FIG. 4 or FIG. 5. Implementation principles and technical effects are similar, and details are not described herein again.

FIG. 11 is a schematic structural diagram of user equipment according to still another embodiment of the present disclosure. The user equipment includes a sending module 1101 and a receiving module 1102. The sending module 1101 is configured to send a first indication message to a network device, where the first indication message is used to indicate that the user equipment (UE) does not meet a cell reselection condition. The receiving module 1102 is configured to receive a second instruction message sent by the network device, where the second instruction message is used to instruct the UE to use, as a candidate cell, a non-camped cell that meets a preset condition, so that the UE selects, from at least one candidate cell, a cell corresponding to maximum parameter information as a new camped cell, or selects, from at least one candidate cell, any candidate cell as a new camped cell. The preset condition is used to ensure that parameter information of the non-camped cell is greater than parameter information of a camped cell.

The parameter information includes reference signal received power (RSRP) or reference signal received quality (RSRQ).

The preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The network device is a base station or an operations support system (OSS) device.

The user equipment provided in this embodiment may be configured to perform the method steps corresponding to the user equipment in the embodiment shown in FIG. 5. Implementation principles and technical effects are similar, and details are not described herein again.

FIG. 12 is a schematic structural diagram of user equipment according to an embodiment of the present disclosure. The user equipment includes a processor 1201 and a memory 1202. The processor 1201 is configured to determine whether the user equipment needs to reselect a cell. If the user equipment does not need to reselect the cell, the processor 1201 obtains parameter information of a camped cell and parameter information of at least one non-camped cell. The processor 1201 is further configured to determine, according to the parameter information of the camped cell and parameter information of any non-camped cell, whether a preset condition is met. If the preset condition is met, the user equipment uses the corresponding non-camped cell as a candidate cell. The processor 1201 is further configured to: select, from at least one candidate cell, a cell corresponding to maximum parameter information as a new camped cell, or select, from at least one candidate cell, any candidate cell as a new camped cell. The preset condition is used to ensure that the parameter information of the non-camped cell is greater than the parameter information of the camped cell. The memory 1202 is configured to store code corresponding to the actions performed by the processor.

The parameter information includes reference signal received power (RSRP) or reference signal received quality (RSRQ).

Further, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The user equipment provided in this embodiment may be configured to perform the method steps in the embodiment shown in FIG. 1. Implementation principles and technical effects are similar, and details are not described herein again.

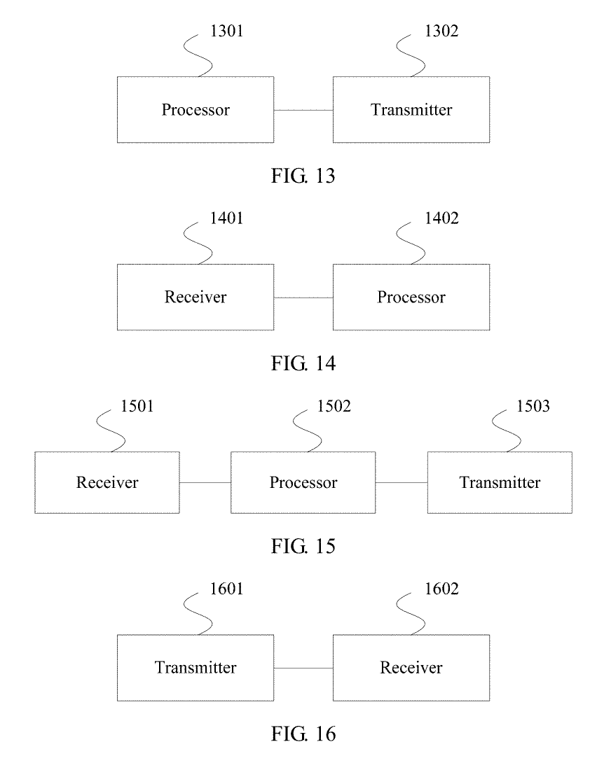

FIG. 13 is a schematic structural diagram of user equipment according to another embodiment of the present disclosure. The user equipment includes a processor 1301 and a transmitter 1302. The processor 1301 is configured to determine whether the user equipment needs to reselect a cell. If the user equipment does not need to reselect the cell, the processor 1301 obtains parameter information of a camped cell and parameter information of at least one non-camped cell. The processor 1301 is further configured to determine, according to the parameter information of the camped cell and parameter information of any non-camped cell, whether a preset condition is met. If the preset condition is met, the transmitter 1302 sends an indication message to a network device, where the indication message is used to indicate that the camped cell is a poor camped cell, or the indication message is used to indicate a quantity of times the camped cell is a poor camped cell, so that the network device performs radio frequency (RF) optimization on the camped cell or optimizes a reselection parameter of the camped cell. The user equipment camps on an optimized camped cell. The preset condition is used to ensure that the parameter information of the non-camped cell is greater than the parameter information of the camped cell.

The parameter information includes reference signal received power (RSRP) or reference signal received quality (RSRQ).

Further, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The network device is a base station or an operations support system (OSS) device.

The user equipment provided in this embodiment may be configured to perform the method steps corresponding to the UE in the embodiment shown in FIG. 2. Implementation principles and technical effects are similar, and details are not described herein again.

FIG. 14 is a schematic structural diagram of a network device according to an embodiment of the present disclosure. The network device includes a receiver 1401 and a processor 1402. The receiver 1401 is configured to receive an indication message sent by user equipment (UE), where the indication message is used to indicate that a camped cell is a poor camped cell, or the indication message is used to indicate a quantity of times that a camped cell is a poor camped cell. The processor 1402 is configured to: perform radio frequency (RF) optimization on the camped cell or optimize a reselection parameter of the camped cell, so that the UE camps on an optimized camped cell.

The network device is a base station or an operations support system (OSS) device.

The network device provided in this embodiment may be configured to perform the method steps corresponding to the network device in the embodiment shown in FIG. 2. Implementation principles and technical effects are similar, and details are not described herein again.

FIG. 15 is a schematic structural diagram of a network device according to another embodiment of the present disclosure. The network device includes a receiver 1501, a processor 1502, and a transmitter 1503. The receiver 1501 is configured to receive a first indication message sent by user equipment (UE), where the first indication message is used to indicate that the UE does not meet a cell reselection condition. The processor 1502 is configured to obtain measurement data of the UE, where the measurement data includes parameter information of a camped cell and parameter information of at least one non-camped cell of the UE. The processor 1502 is further configured to determine, according to the parameter information of the camped cell and parameter information of any non-camped cell, whether a preset condition is met. If the preset condition is met, the processor 1502 performs radio frequency (RF) optimization on the camped cell or optimizes a reselection parameter of the camped cell, so that the UE camps on an optimized camped cell; or if the preset condition is met, the transmitter 1503 sends a second instruction message to the UE, where the second instruction message is used to instruct the UE to use the corresponding non-camped cell as a candidate cell, so that the UE selects, from at least one candidate cell, a cell corresponding to maximum parameter information as a new camped cell, or selects, from at least one candidate cell, any candidate cell as a new camped cell. The preset condition is used to ensure that the parameter information of the non-camped cell is greater than the parameter information of the camped cell.

Further, the parameter information includes reference signal received power (RSRP) or reference signal received quality (RSRQ).

Still further, the preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The network device is a base station or an operations support system (OSS) device.

The network device provided in this embodiment may be configured to perform the method steps corresponding to the network device in the embodiment shown in FIG. 4 or FIG. 5. Implementation principles and technical effects are similar, and details are not described herein again.

FIG. 16 is a schematic structural diagram of user equipment according to still another embodiment of the present disclosure. The user equipment includes a transmitter 1601 and a receiver 1602. The transmitter 1601 is configured to send a first indication message to a network device, where the first indication message is used to indicate that the user equipment (UE) does not meet a cell reselection condition. The receiver 1602 is configured to receive a second instruction message sent by the network device, where the second instruction message is used to instruct the UE to use, as a candidate cell, a non-camped cell that meets a preset condition, so that the UE selects, from at least one candidate cell, a cell corresponding to maximum parameter information as a new camped cell, or selects, from at least one candidate cell, any candidate cell as a new camped cell. The preset condition is used to ensure that parameter information of the non-camped cell is greater than parameter information of a camped cell.

The parameter information includes reference signal received power (RSRP) or reference signal received quality (RSRQ).

The preset condition includes: the parameter information of the camped cell is less than a first threshold, and the parameter information of the non-camped cell is greater than a second threshold; and/or a difference between the parameter information of the non-camped cell and the parameter information of the camped cell is greater than a third threshold.

The network device is a base station or an operations support system (OSS) device.

The user equipment provided in this embodiment may be configured to perform the method steps corresponding to the user equipment in the embodiment shown in FIG. 5. Implementation principles and technical effects are similar, and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The storage medium includes any medium that can store program code, such as a ROM, a RAM, a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. An apparatus of user equipment (UE), comprising:
a processor configured to:
determine whether the user equipment needs to reselect a cell,
when the UE does not need to reselect the cell, obtain parameter information of a camped cell and parameter information of at least one non-camped cell, and determine, according to the parameter information of the camped cell and parameter information of any non-camped cell, whether a preset condition is met
a transmitter configured to: when the preset condition is met, send an indication message to a network device for indicating that the camped cell is a poor camped cell or for indicating a quantity of times that the camped cell is a poor camped cell during a time, and for enabling the network device to perform radio frequency (RF) optimization on the camped cell or optimize a reselection parameter of the camped cell;
wherein the processor is further configured to determine that the user equipment camps on an optimized camped cell; and
wherein the preset condition is used to ensure that the parameter information of the non-camped cell is greater than the parameter information of the camped cell.

2. The apparatus according to claim 1, wherein the preset condition is met when the parameter information of the camped cell is less than a first threshold, and the parameter information of the non-camped cell is greater than a second threshold.

3. The apparatus according to claim 1, wherein a difference between the parameter information of the non-camped cell and the parameter information of the camped cell is greater than a third threshold.

4. An apparatus of a network device, comprising:
a receiver configured to receive an indication message sent by user equipment (UE), wherein the indication message is used to indicate that a camped cell is a poor camped cell or used to indicate a quantity of times that a camped cell is a poor camped cell during a time; and
a processor configured to: perform radio frequency (RF) optimization on the camped cell or optimize a reselection parameter of the camped cell to enable the UE to camp on an optimized camped cell.

5. An apparatus of user equipment (UE), comprising:
a transmitter, configured to send a first indication message to a network device for indicating that the UE does not meet a cell reselection condition;
a receiver, configured to receive a second instruction message sent by the network device, wherein the second instruction message is used to instruct the UE to use, as a candidate cell, a non-camped cell that meets a preset condition;
a processor, configured to select, from at least one candidate cell, a cell corresponding to maximum parameter information as a new camped cell, or select, from at least one candidate cell, any candidate cell as a new camped cell; and
wherein the preset condition is used to ensure that parameter information of the non-camped cell is greater than parameter information of a camped cell.

6. The apparatus according to claim 5, wherein the preset condition comprises: the parameter information of the camped cell is less than a first threshold, and the parameter information of the non-camped cell is greater than a second threshold.

7. The apparatus according to claim 5, wherein a difference between the parameter information of the non-camped cell and the parameter information of the camped cell is greater than a third threshold.
